(19) United States
(12) Patent Application Publication
(10) Pub. No.: US 2025/0328386 A1
(43) Pub. Date: Oct. 23, 2025

(54) Policy-Based Tagging Governance for Cloud Resource Lifecycle Management

(71) Applicant: Dell Products L.P., Round Rock, TX (US)

(72) Inventors: Ching-Yun Chao, Austin, TX (US); Sumedh Sathaye, Austin, TX (US); Vinay Sawal, Fremont, CA (US); Tsehsin Jason Liu, Wellesley, MA (US)

(21) Appl. No.: 18/639,707

(22) Filed: Apr. 18, 2024

(51) Int. Cl. G06F 9/50

(52) U.S. Cl. CPC G06F 9/5027

(57) ABSTRACT

A system can maintain a relational resource model, wherein respective tags, respective policies, and respective computing resources are modeled in the relational resource model as respective resources. The system can, based on receiving a request to create a new computing resource, identify a tag template, wherein the tag template corresponds to a resource type of the new computing resource. The system can, based on determining that the new computing resource satisfies a policy of the respective policies that corresponds to the resource type, create the new computing resource, and create a representation of the new computing resource in the relational resource model. The system can associate a tag of the respective tags with the representation of the new computing resource in the relational resource model, based on the tag template, to produce an updated relational resource model. The system can store the updated relational resource model in a computing memory.

### BACKGROUND

A computer system can comprise various resources, and these resources can be associated with metadata that describes these resources.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can maintain a relational resource model, wherein respective tags are modeled in the relational resource model as respective first resources, respective policies are modeled in the relational resource model as respective second resources, and respective computing resources are modeled in the relational resource model as respective third resources. The system can, based on receiving a request to create a new computing resource, identify a tag template, wherein the tag template corresponds to a resource type of the new computing resource. The system can, based on determining that the new computing resource satisfies a policy of the respective policies that corresponds to the resource type, create the new computing resource, and create a representation of the new computing resource in the relational resource model. The system can associate a tag of the respective tags with the representation of the new computing resource in the relational resource model, based on the tag template, to produce an updated relational resource model. The system can store the updated relational resource model in a computing memory.

An example method can comprise, based on receiving a request to create a computing resource, identifying, by a system comprising at least one processor, a tag template of a relational resource model wherein respective tags are modeled as respective first resources, respective policies are modeled as respective second resources, respective computing resources are modeled as respective third resources, and wherein the tag template corresponds to a resource type of the computing resource. The method can further comprise, based on determining that the computing resource satisfies a policy of the respective policies that corresponds to the resource type. The method can further comprise creating, by the system, the computing resource. The method can further comprise creating, by the system, a representation of the computing resource in the relational resource model. The method can further comprise associating, by the system, a tag of the respective tags with the representation of the computing resource in the relational resource model, based on the tag template, to produce an updated relational resource model.

An example non-transitory computer-readable medium can comprise instructions that, in response to execution, cause a system comprising a processor to perform operations. These operations can comprise, based on receiving a request to create a computer resource, identifying a tag template of a relational resource model that models respective tags, respective policies, and respective computer resources as respective resources, and wherein the tag template corresponds to a resource type of the computer resource. These operations can further comprise, based on determining that the computer resource satisfies a policy of the respective policies, creating the computer resource, and creating a representation of the computer resource in the relational resource model. These operations can comprise associating a tag of the respective tags with the representation of the computer resource in the relational resource model, based on the tag template.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate policy-based tagging governance for cloud resource lifecycle management, in accordance with an embodiment of this disclosure;

FIG. 2 illustrates an example system architecture of a relational tag resource model that can facilitate policy-based tagging governance for cloud resource lifecycle management, in accordance with an embodiment of this disclosure;

FIG. 3 illustrates an example system architecture for tagging resource automation that can facilitate policy-based tagging governance for cloud resource lifecycle management, in accordance with an embodiment of this disclosure;

FIG. 4 illustrates an example tag template that can facilitate policy-based tagging governance for cloud resource lifecycle management, in accordance with an embodiment of this disclosure;

FIG. 5 illustrates an example process flow that can facilitate policy-based tagging governance for cloud resource lifecycle management, in accordance with an embodiment of this disclosure;

FIG. 6 illustrates another example process flow that can facilitate policy-based tagging governance for cloud resource lifecycle management, in accordance with an embodiment of this disclosure;

FIG. 7 illustrates another example process flow that can facilitate policy-based tagging governance for cloud resource lifecycle management, in accordance with an embodiment of this disclosure;

FIG. 8 illustrates another example process flow that can facilitate policy-based tagging governance for cloud resource lifecycle management, in accordance with an embodiment of this disclosure;

FIG. 9 illustrates another example process flow that can facilitate policy-based tagging governance for cloud resource lifecycle management, in accordance with an embodiment of this disclosure;

FIG. 10 illustrates another example process flow that can facilitate policy-based tagging governance for cloud resource lifecycle management, in accordance with an embodiment of this disclosure;

FIG. 11 illustrates another example process flow that can facilitate policy-based tagging governance for cloud resource lifecycle management, in accordance with an embodiment of this disclosure;

FIG. 12 illustrates an example block diagram of a computer operable to execute an embodiment of this disclosure.

### DETAILED DESCRIPTION

### Overview

Cloud service vendors can facilitate tagging resources. A typical usage scenario can be to define arbitrary group of resources by attaching a tag to resources. Resources that are tagged by the same tag can form a group resources. It can be that prior tagging service implementations lack a way to manage the lifecycle of tags (e.g., create a tag, modify a tag, and delete a tag) and resource group life cycles (e.g., attaching a tag to a resource and detaching a tag from a resource). Those operations can tend to be manually handled by users, which can be a significant overhead on resource lifecycle management, resource group lifecycle management, and tag lifecycle management.

A cloud resource can comprise an object that is useful to cloud services. Examples of cloud services can include infrastructure as a service (IaaS), platform as a service (PaaS), software as a service (SaaS), storage as a service, data as a service, etc. Examples of cloud resources can include virtual machines, virtual storages, virtual servers, virtual hosts, hosts, servers, virtual devices, devices, accounts, users, groups, random access memories (RAMs), central processing units (CPUs), solid state drives (SSDs), etc.

Resource life cycle management can generally comprise managing the creation, updating, and deleting of a resource. Creating a cloud resource such as a virtual machine can generally mean that a new virtual machine is created by running an image of a virtual machine on the cloud, so a new instance of a virtual machine is instantiated. The virtual machine can be used to run an application, a configuration of the application can be changed to change the application behavior (e.g., modify the virtual machine resource). When that is done, the virtual machine can be deleted. A tag can be created (e.g., virtual machines for this month) that can be attached to virtual machines used this month.

Furthermore, cloud resources can generally comprise services offered by a cloud computing platform, such as compute, storage, transmission/reception resources via servers, network nodes, storage equipment, data storage equipment, such as databases, networking equipment, software services, firmware services, hardware services, analytics resources, and data intelligence resources. Cloud resource lifecycle management can generally comprise software, firmware, and/or hardware employed in initiating, maintaining, modifying, ending, and otherwise managing the lifecycle of a cloud resource.

Some approaches to tagging in cloud services can assign tags as metadata (e.g., key-value pairs) to annotate cloud resources to enhance a resource management capability, such as resource identification, resource organization, or resource searching and filtering.

A tagging feature can provide benefits such as attribute based access control, cloud financial management, and cloud resource lifecycle management automation.

A problem with prior approaches to tagging in cloud services can be that proper tagging of resources is a manual process. It can be that adding an initial tag when a resource is created is also a manual process. And it can be that extensive tagging is used to obtain granular data on tagged resources. Put another way, a problem with prior approaches can be that managing lifecycle of tags is an endless job.

Some prior approaches to cloud model tagging can incorporate it as part of a hierarchical resource model, can support tag inheritance, and can attach identity access management (IAM) policies to tags.

Some prior approaches to cloud model tagging can use a policy to enforce rules and effects on resources in users' subscriptions. A policy can be applied to automate tagging according to a user organization's tagging conventions. That is, in a manner, resource tagging can be enforced by blocking resource creation if the resource-to-be-created lacks the necessary tags.

While prior approaches can facilitate enforcing creating required tags, and enforcing tags' IAM policy control, creating and managing tags can be still a manual process. In contrast, the present techniques can be implemented to facilitate a solution that can fully-automate tagging governance.

In some examples, the present techniques can be implemented on a software-as-a-service (SaaS) platform that utilizes a hierarchical resource model. In some examples, this platform can support enforcing an attribute-based access control (ABAC) policy on resources.

The present techniques can be implemented to automate creating tagging governance by modeling tags as part of a relational resource model; by using an attribute-based tagging policy to automate tag creation and lifecycle management; and by facilitating organic growth of tagging that adheres to this modeling.

The present techniques can be implemented to automate tagging new resources upon creation using a tag template policy. The present techniques can be implemented to model tag, resource type, tag template, and policy using resource model patterns. The present techniques can be implemented to extend a TANGO ABAC policy to define an Attribute-Based Tag Template (ABTT) policy. In other words, there can be a common policy language across access control and tagging governance.

New tags can be modelled via binding as resource attributes. New tags can be used by an ABTT policy as attributes to define new tags. This can be a form of organic growth of tagging via the present techniques.

The present techniques can be implemented to facilitate automated tag lifecycle management handling tag modification, and tag deletion using a tag resource backlink to a tag template (tag-template-id).

### Example Architectures, Etc.

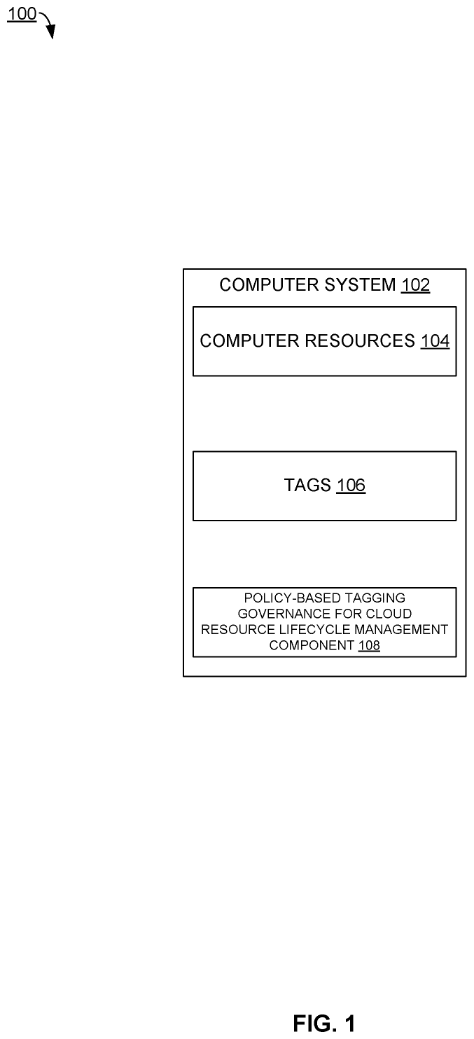

FIG. 1 illustrates an example system architecture 100 that can facilitate policy-based tagging governance for cloud resource lifecycle management, in accordance with an embodiment of this disclosure.

System architecture 100 comprises computer system 102, computer resources 104, tags 106, and policy-based tagging governance for cloud resource lifecycle management component 108.

System architecture 100 presents one logical example of implementing the present techniques, and it can be appreciated that there can be other example architectures.

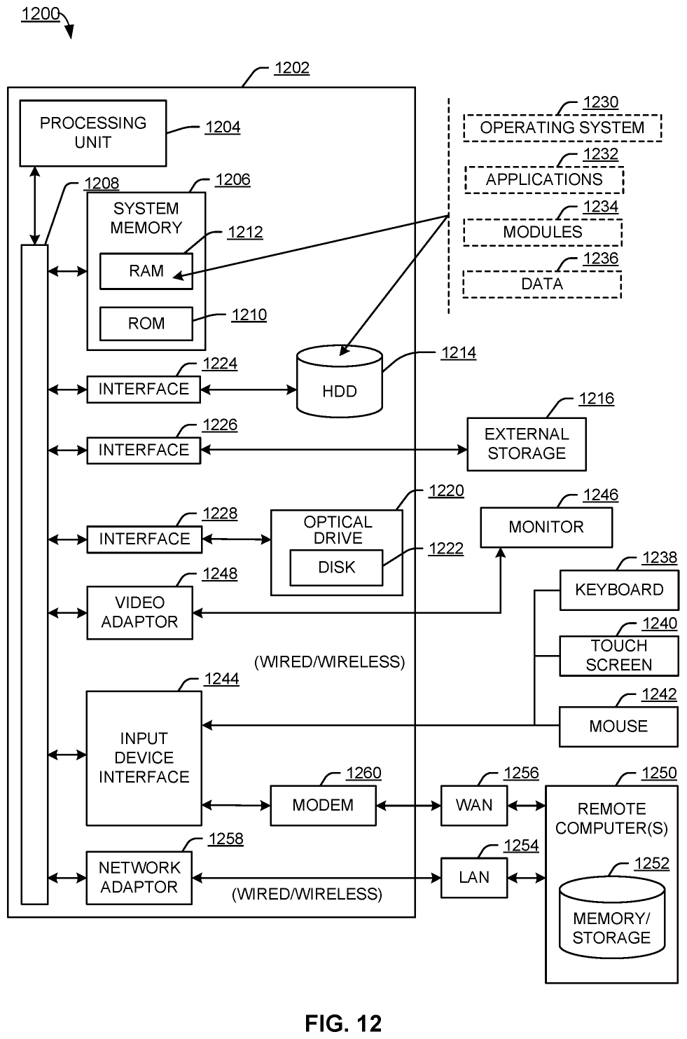

Computer system 102 can be implemented with part(s) of computing environment 1200 of FIG. 12.

Computer system 102 can comprise computer resources 104, which can each be tagged with one or more tags of tags 106.

In some examples, policy-based tagging governance for cloud resource lifecycle management component 108 can facilitate policy-based tagging governance for cloud resource lifecycle management of computer resources 104 with tags 106. This can involve facilitating modeling a tag as an integral part of a relational resource model, using an attribute-based tagging policy to automate tag creating and lifecycle management, and/or allowing organic growth of tagging adhering to the same modeling.

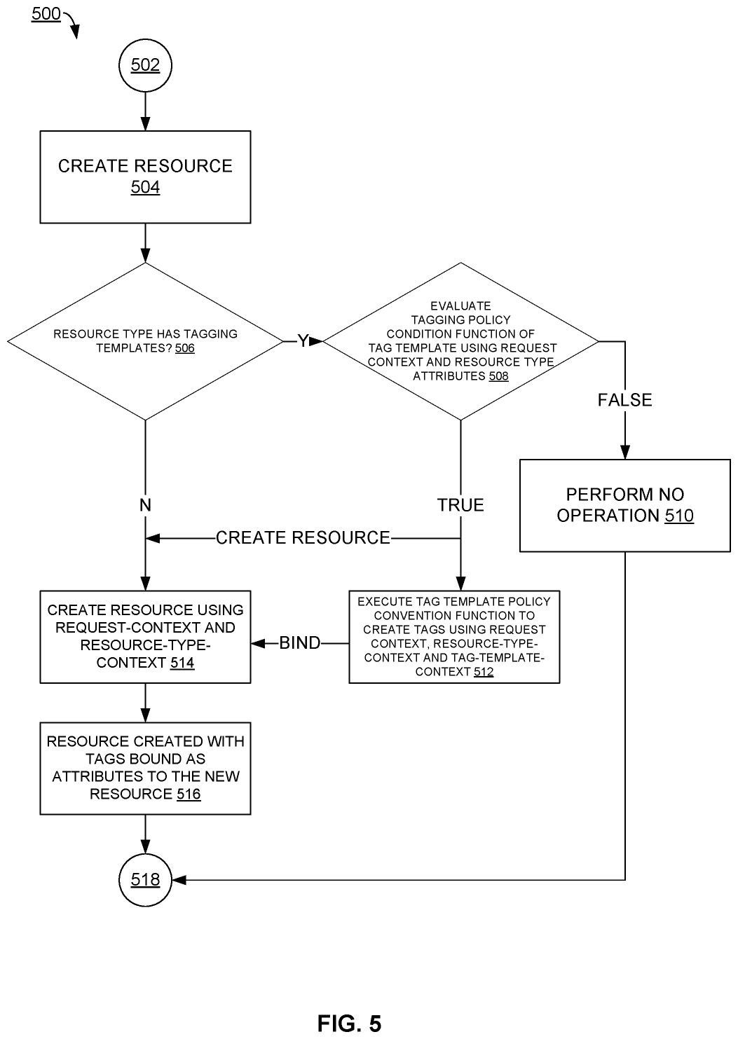

In some examples, policy-based tagging governance for cloud resource lifecycle management component 108 can implement part(s) of the process flows of FIGS. 5-11 to implement policy-based tagging governance for cloud resource lifecycle management.

It can be appreciated that system architecture 100 is one example system architecture for policy-based tagging governance for cloud resource lifecycle management, and that there can be other system architectures that facilitate policy-based tagging governance for cloud resource lifecycle management.

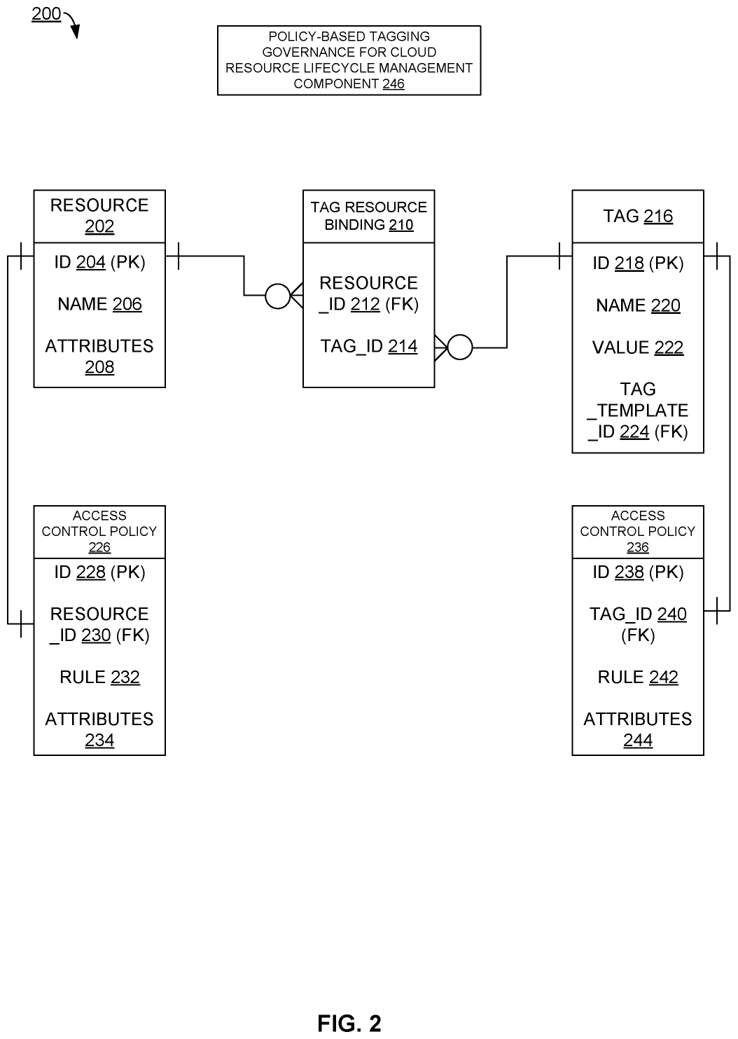

FIG. 2 illustrates an example system architecture 200 of a relational tag resource model that can facilitate policy-based tagging governance for cloud resource lifecycle management, in accordance with an embodiment of this disclosure. In some examples, part(s) of system architecture 200 can be used to implement part(s) of system architecture 100 of FIG. 1 to facilitate tagging governance for cloud resource lifecycle management.

System architecture 200 comprises resource 202, id 204 (primary key (PK), which can uniquely identify a row in a table), name 206, attributes 208, tag resource binding 210, resource_id 212 (foreign key (FK), which can alone or with another foreign key, identify a link between data in two tables and specify what data can be stored in a foreign key table), tag_id 214, tag 216, id 218 (PK), name 220, value 222, tag_template_id 224 (FK), access control policy 226, id 228 (PK), resource_id 230 (FK), rule 232, attributes 234, access control policy 236, id 238 (PK), tag_id 240 (FK), rule 242, attributes 244, and policy-based tagging governance for cloud resource lifecycle management component 246 (which can be similar to policy-based tagging governance for cloud resource lifecycle management component 108 of FIG. 1).

With a relational tag resource model, as according to examples of the present techniques, a tag can be modeled as a resource. A policy can be modeled as a resource. Zero or more tags can bind with zero or more resources. One ABAC policy can bind to one resource. One ABAC policy can bind to one tag (where a tag can be a type of resource).

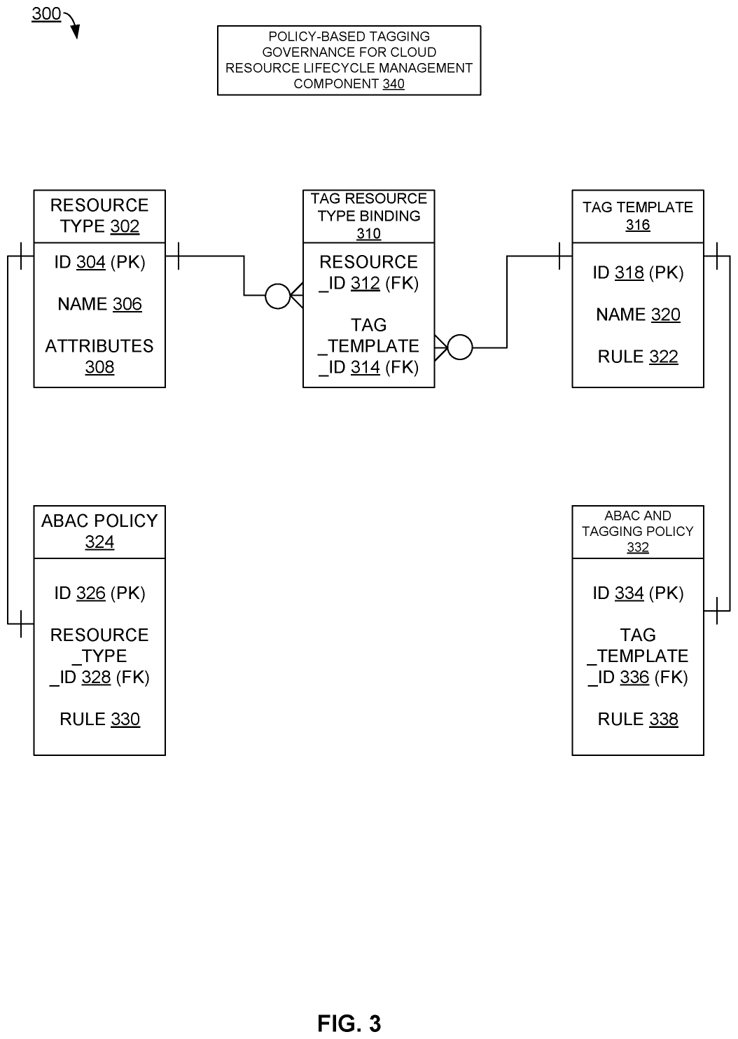

FIG. 3 illustrates an example system architecture 300 for tagging resource automation that can facilitate policy-based tagging governance for cloud resource lifecycle management, in accordance with an embodiment of this disclosure. In some examples, part(s) of system architecture 300 can be used to implement part(s) of system architecture 100 of FIG. 1 to facilitate tagging governance for cloud resource lifecycle management.

System architecture 300 comprises resource type 302, id 304 (PK), name 306, attributes 308, tag resource type binding 310, resource_id 312 (FK), tag_template_id 314 (FK), tag template 316, id 318 (PK), name 320, rule 322, ABAC policy 324, id 326 (PK), resource_type_id 328 (FK), rule 330, ABAC and tagging policy 332, id 334 (PK), tag_template_id 336 (FK), rule 338, and policy-based tagging governance for cloud resource lifecycle management component 340 (which can be similar to policy-based tagging governance for cloud resource lifecycle management component 108 of FIG. 1).

In some examples, the present techniques can be implemented to facilitate tagging resource automation, as follows. Tagging can be performed automatically when creating a resource. A resource type can bind to zero or more tag templates. When creating a new resource, tag templates of the resource type can be checked, and a new tag can be created and attached to the new resource if a tag template rule is matched.

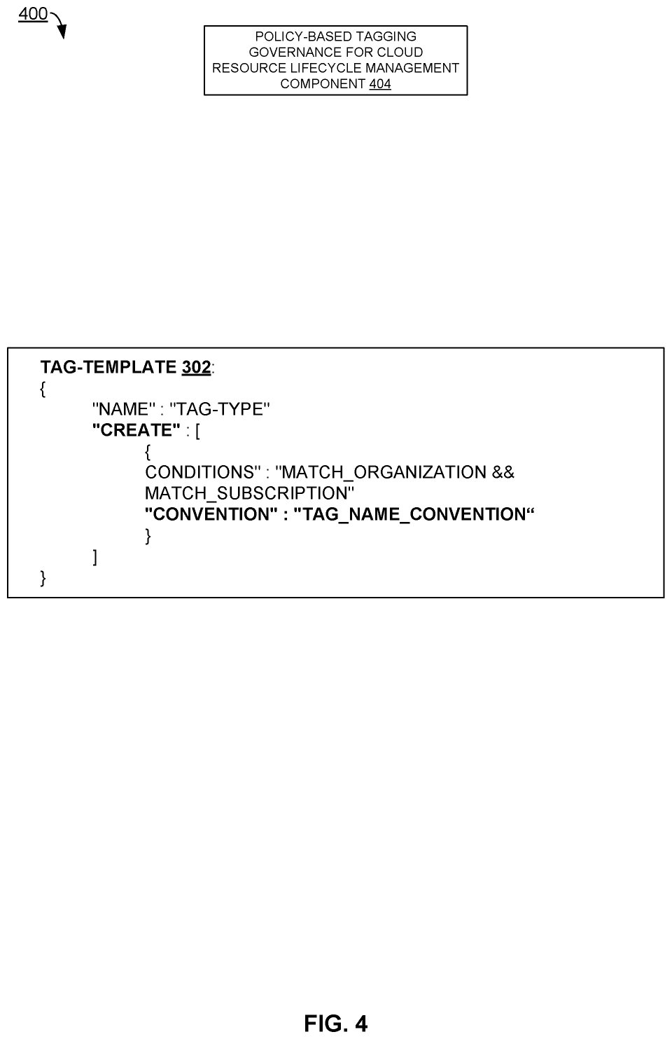

FIG. 4 illustrates an example tag template 400 that can facilitate policy-based tagging governance for cloud resource lifecycle management, in accordance with an embodiment of this disclosure. In some examples, part(s) of tag template 400 can be used to implement part(s) of system architecture 100 of FIG. 1 to facilitate tagging governance for cloud resource lifecycle management.

Tag template 400 comprises tag template 402 and policy-based tagging governance for cloud resource lifecycle management component 404 (which can be similar to policy-based tagging governance for cloud resource lifecycle management component 108 of FIG. 1).

A tag type model can facilitate policy-driven tag automation. A tag template rule can be defined using a variation of conditions and condition functions.

This approach can be extended to other operations: update, delete, etc.

Conditions, condition functions, and convention functions can be implemented as follows.
Conditions can comprise a Boolean expression (e.g., TRUE or FALSE) of one or more conditions. A condition can comprise a pre-defined condition, such as
Match_Organization, Match_Subscription, Match_Site, Match_Region, etc.

A policy service can evaluate a condition by calling a registered condition function, such as:
Boolean condition-function (request-context, resource-type-context)

In this function, request-context can identify requester context data, and resource-type-context can identify resource type context data.

A tag service can use a registered tag convention function, which can generate a new tag resource, such as the following which uses a JavaScript Object Notation (JSON) schema:
JSON convention-function (request-context, resource-type-context, tag-template-context)

This function can return a JOSN object that represents a new tag resource including unique id, name, value, and other attributes.

### Example Process Flows

FIG. 5 illustrates an example process flow 500 that can facilitate policy-based tagging governance for cloud resource lifecycle management, in accordance with an embodiment of this disclosure. In some examples, one or more embodiments of process flow 500 can be implemented by policy-based tagging governance for cloud resource lifecycle management component 108 of FIG. 1, or computing environment 1200 of FIG. 12.

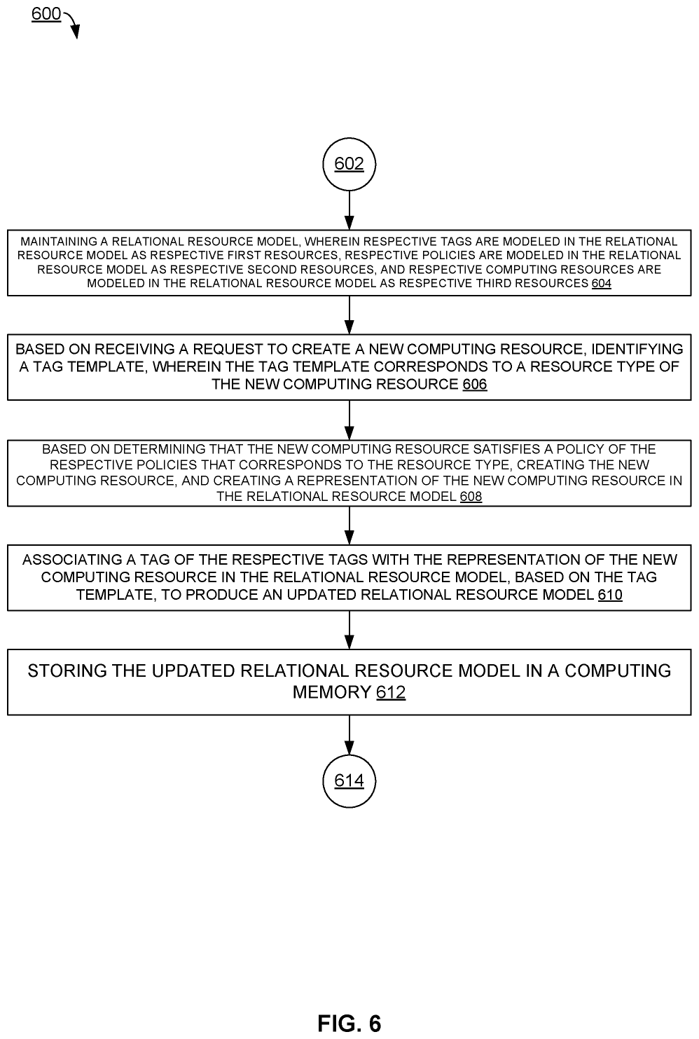

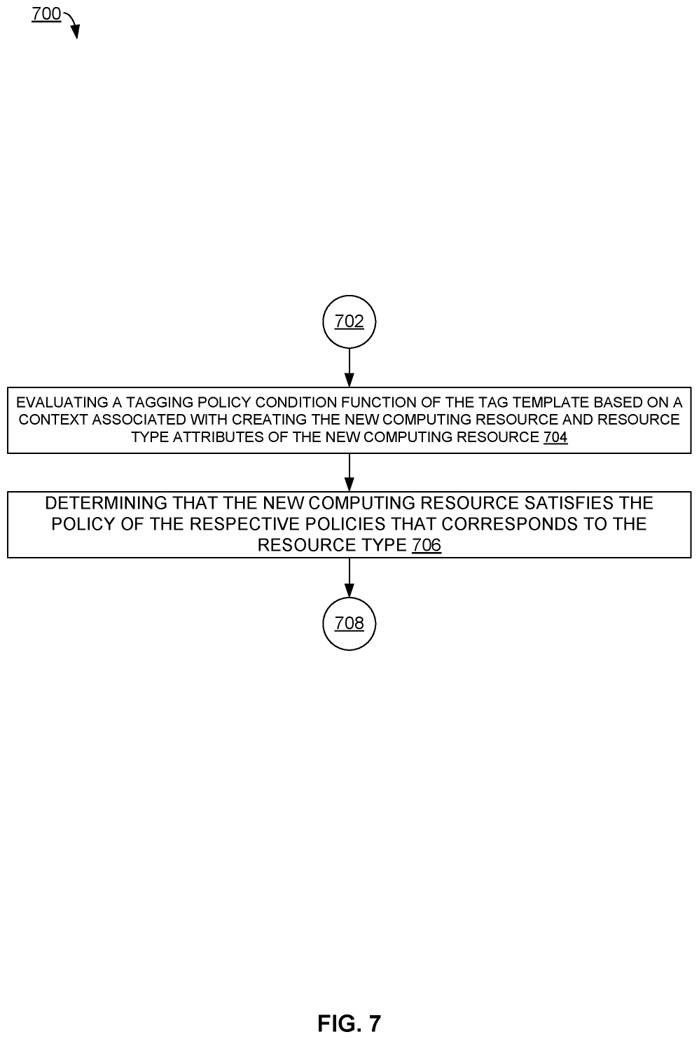

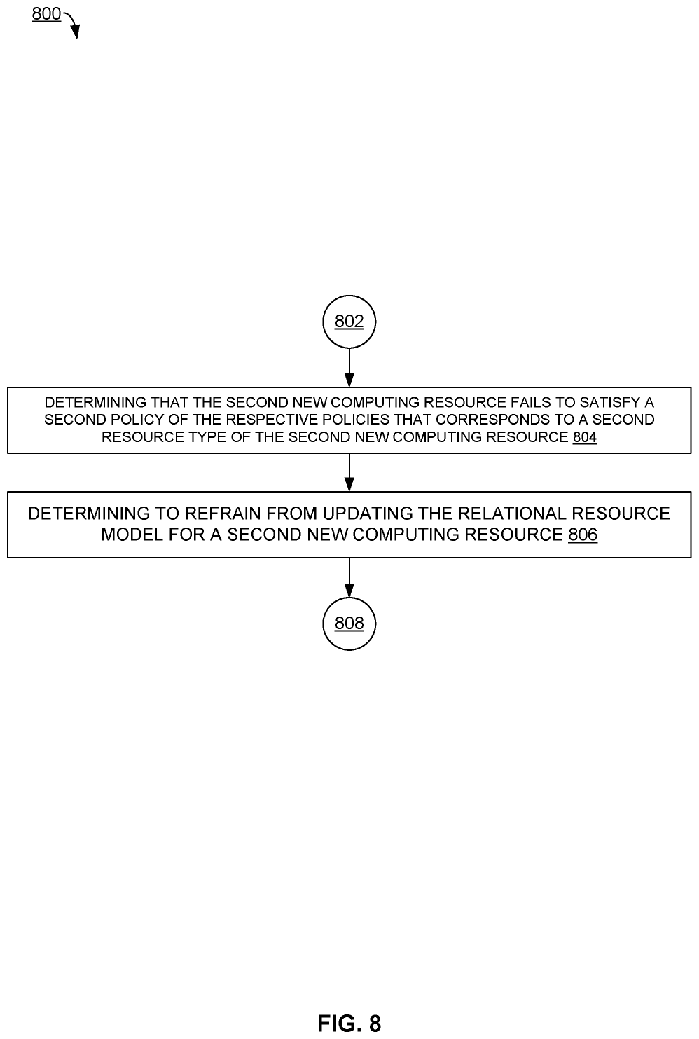

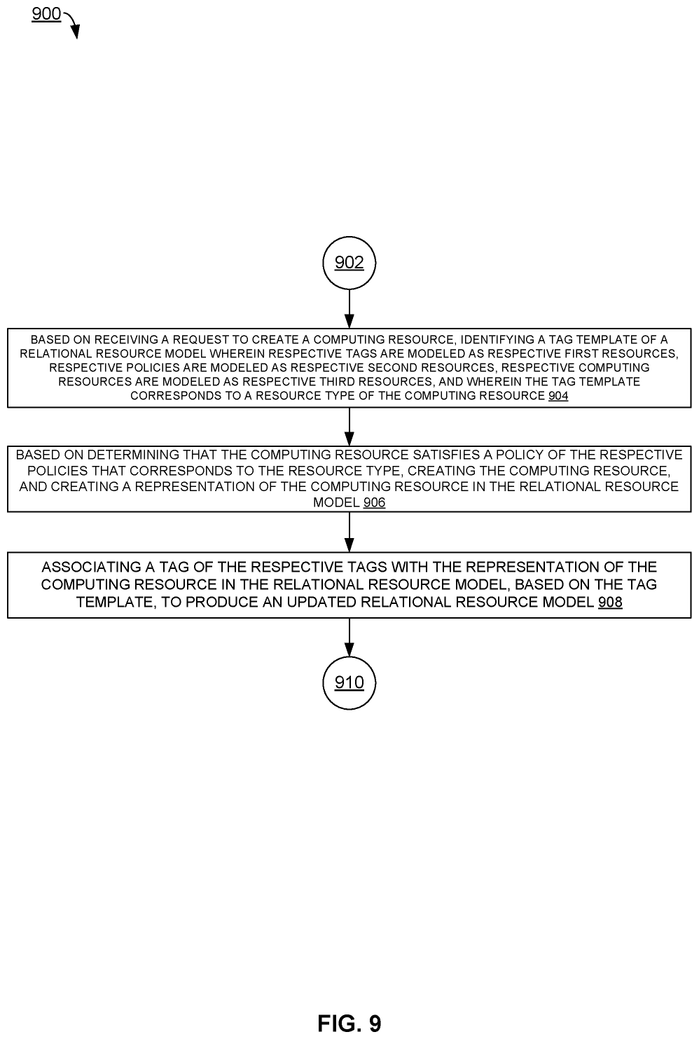

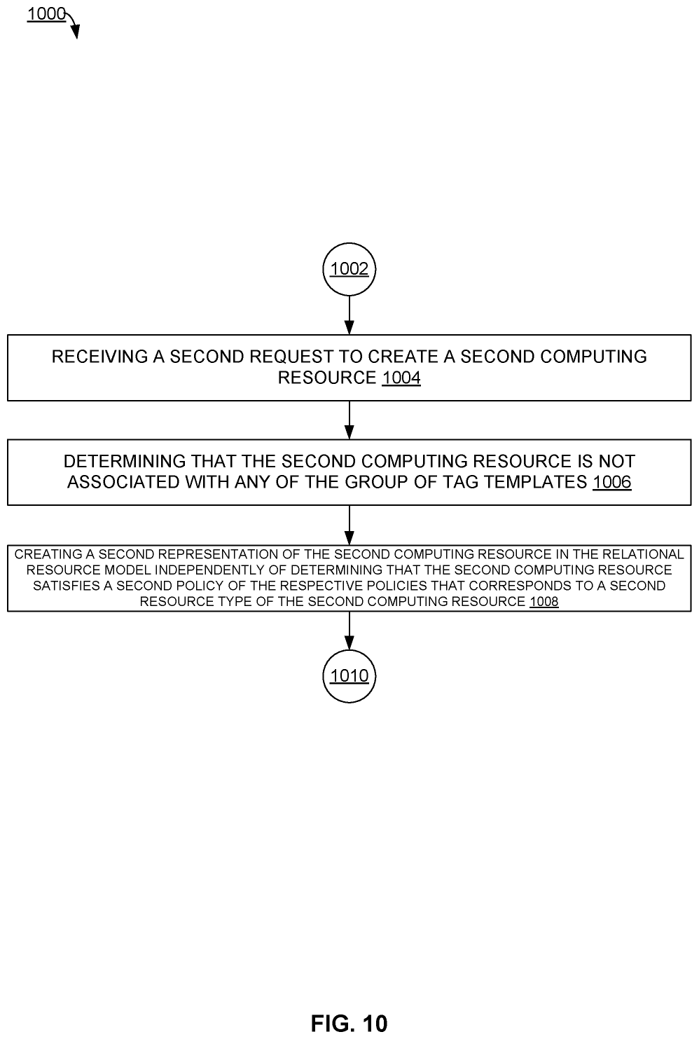

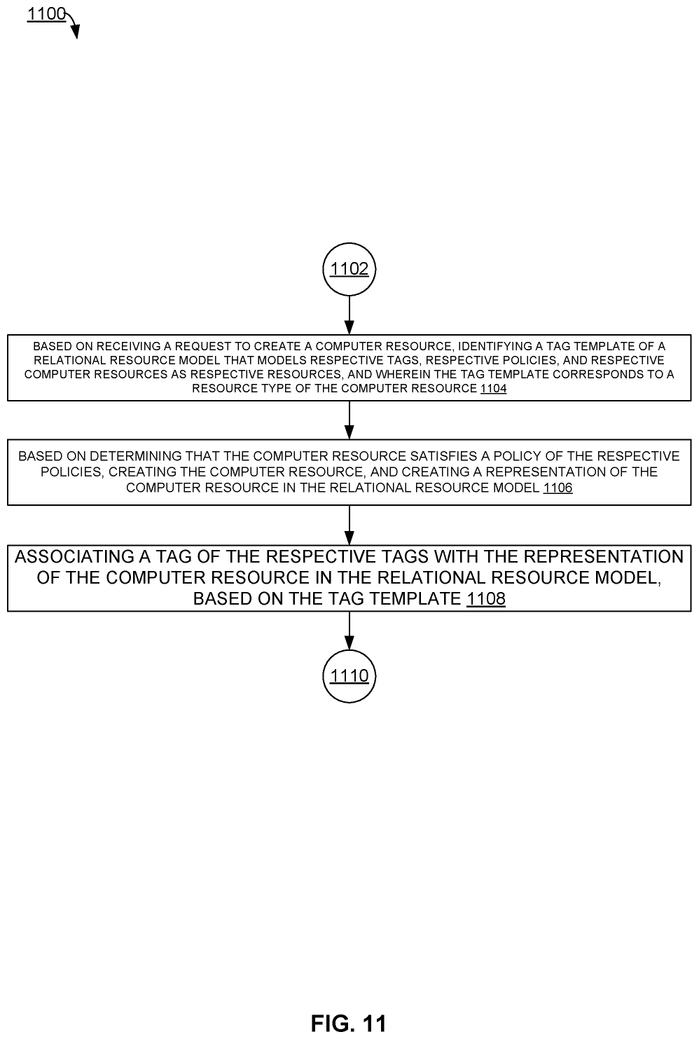

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 500 begins with 502, and moves to operation 504.

Operation 504 depicts creating a resource.

After operation 506, process flow 500 moves to operation 506.

Operation 506 depicts determining whether a resource type has tagging templates.

Where it is determined in operation 506 that a resource type has tagging templates, process flow 500 moves to operation 508. Instead, where it is determined in operation 506 that a resource type has tagging templates, process flow 500 moves to operation 514.

Operation 508 is reached from operation 506 where it is determined that a resource type has tagging templates. Operation 508 depicts evaluating a tagging policy condition function of tag template using request context and resource type attributes.

Where the evaluation in operation 508 results in false, process flow 500 moves to operation 510. Instead, where the evaluation in operation 508 results in true, process flow 500 moves to operations 514 (to create a resource) and 512 (to create tags that are bound to the resource).

Operation 510 is reached from operation 508 where the evaluation results in false. Operation 510 depicts performing no operation.

After operation 512, process flow 500 moves to 518, where process flow 500 ends.

Operation 512 is reached from operation 508 where the evaluation results in true. Operation 512 depicts executing a tag template policy convention function to create tags using request context, resource-type-context and tag-template-context.

After operation 512, process flow 500 moves to operation 514, where the tag(s) created in operation 512 are bound to the resource.

Operation 514 is reached from operation 508 (where the evaluation results in true) or operation 512. Operation 514 depicts creating a resource using request-context and resource-type-context.

After operation 514, process flow 500 moves to operation 516.

Operation 516 depicts determining that the resource is created with tags bound as attributes to the new resource.

After operation 516, process flow 500 moves to 518, where process flow 500 ends.

FIG. 6 illustrates an example process flow 600 that can facilitate policy-based tagging governance for cloud resource lifecycle management, in accordance with an embodiment of this disclosure. In some examples, one or more embodiments of process flow 600 can be implemented by policy-based tagging governance for cloud resource lifecycle management component 108 of FIG. 1, or computing environment 1200 of FIG. 12.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, process flow 800 of FIG. 8, process flow 900 of FIG. 9, process flow 1000 of FIG. 10, and/or process flow 1100 of FIG. 11.

Process flow 600 begins with 602, and moves to operation 604.

Operation 604 depicts maintaining a relational resource model, wherein respective tags are modeled in the relational resource model as respective first resources, respective policies are modeled in the relational resource model as respective second resources, and respective computing resources are modeled in the relational resource model as respective third resources. That is, there can be a relational resource model that supports enforcing an ABAC policy on resources. A tag can be modeled as a resource, and a policy can also be modeled as a resource.

After operation 604, process flow 600 moves to operation 606.

Operation 606 depicts, based on receiving a request to create a new computing resource, identifying a tag template, wherein the tag template corresponds to a resource type of the new computing resource. That is, when creating a new resource, tag templates of the resource type can be checked, and a new tag can be created and attached to the new resource if a tag template rule matches.

After operation 606, process flow 600 moves to operation 608.

Operation 608 depicts, based on determining that the new computing resource satisfies a policy of the respective policies that corresponds to the resource type, creating the new computing resource, and creating a representation of the new computing resource in the relational resource model. That is, when creating a new resource, tag templates of the resource type can be checked, and a new tag can be created and attached to the new resource if a tag template rule matches.

In some examples, creating the new computing resource is performed based on a use request context and a resource type context. In some examples, this can be performed in a similar manner as operation 514 of FIG. 5.

In some examples, operation 608 comprises executing a tag template convention function to create the tag based on a request context, a resource type context, and a tag template context. In some examples, the executing of the tag template convention function is performed based on determining that the new computing resource satisfies the policy. This can be performed in a similar manner as operation 514 of FIG. 5.

After operation 608, process flow 600 moves to operation 610.

Operation 610 depicts associating a tag of the respective tags with the representation of the new computing resource in the relational resource model, based on the tag template, to produce an updated relational resource model. That is, when creating a new resource, tag templates of the resource type can be checked, and a new tag can be created and attached to the new resource if a tag template rule matches.

In some examples, operation 610 comprises binding the tag with the representation of the new computing resource as an attribute of the representation of the new computing resource. This can be the bind operation between operations 512 and 514 of FIG. 5.

After operation 610, and/or process flow 600 moves to operation 612.

Operation 612 depicts storing the updated relational resource model in a computing memory. That is, this relational resource model can be saved and used for determining whether users are granted access to particular resources.

After operation 612, process flow 600 moves to 614, where process flow 600 ends.

FIG. 7 illustrates an example process flow 700 that can facilitate policy-based tagging governance for cloud resource lifecycle management, in accordance with an embodiment of this disclosure. In some examples, one or more embodiments of process flow 700 can be implemented by policy-based tagging governance for cloud resource lifecycle management component 108 of FIG. 1, or computing environment 1200 of FIG. 12.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, process flow 900 of FIG. 9, process flow 1000 of FIG. 10, and/or process flow 1100 of FIG. 11.

Process flow 700 begins with 702, and moves to operation 704.

Operation 704 depicts evaluating a tagging policy condition function of the tag template based on a context associated with creating the new computing resource and resource type attributes of the new computing resource.

In some examples, the context associated with creating the new computing resource comprises resource parameters.

After operation 704, process flow 700 moves to operation 706.

Operation 706 depicts determining that the new computing resource satisfies the policy of the respective policies that corresponds to the resource type. That is, operations 704-706 can be implemented in a similar manner as operation 508 of FIG. 5.

After operation 706, process flow 700 moves to 708, where process flow 700 ends.

FIG. 8 illustrates an example process flow 800 that can facilitate policy-based tagging governance for cloud resource lifecycle management, in accordance with an embodiment of this disclosure. In some examples, one or more embodiments of process flow 800 can be implemented by policy-based tagging governance for cloud resource lifecycle management component 108 of FIG. 1, or computing environment 1200 of FIG. 12.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, process flow 900 of FIG. 9, process flow 1000 of FIG. 10, and/or process flow 1100 of FIG. 11.

In some examples where process flow 800 is implemented in conjunction with process flow 600, the new computing resource is a first computing resource, the policy is a first policy, and the resource type is a first resource type.

Process flow 800 begins with 802, and moves to operation 804.

Operation 804 depicts determining that the second new computing resource fails to satisfy a second policy of the respective policies that corresponds to a second resource type of the second new computing resource.

After operation 804, process flow 800 moves to operation 806.

Operation 806 depicts determining to refrain from updating the relational resource model for a second new computing resource. That is, operations 804-806 can be implemented in a similar manner as operation 508 of FIG. 5 where evaluating the tagging policy condition function results in a determination of false.

After operation 806, process flow 800 moves to 808, where process flow 800 ends.

FIG. 9 illustrates an example process flow 900 that can facilitate policy-based tagging governance for cloud resource lifecycle management, in accordance with an embodiment of this disclosure. In some examples, one or more embodiments of process flow 900 can be implemented by policy-based tagging governance for cloud resource lifecycle management component 108 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, process flow 800 of FIG. 8, process flow 1000 of FIG. 10, and/or process flow 1100 of FIG. 11.

Process flow 900 begins with 902, and moves to operation 904.

Operation 904 depicts, based on receiving a request to create a computing resource, identifying a tag template of a relational resource model wherein respective tags are modeled as respective first resources, respective policies are modeled as respective second resources, respective computing resources are modeled as respective third resources, and wherein the tag template corresponds to a resource type of the computing resource. In some examples, operation 904 can be implemented in a similar manner as operations 604-606 of FIG. 6.

In some examples, the respective computing resources are respectively associated with no policies or with one policy. That is, it can be that one ABAC policy can bind to one resource.

In some examples, the respective tags are respectively associated with no policies or with one policy. That is, it can be that one ABAC policy can bind to one tag.

After operation 904, process flow 900 moves to operation 906.

Operation 906 depicts, based on determining that the computing resource satisfies a policy of the respective policies that corresponds to the resource type, creating the computing resource, and creating a representation of the computing resource in the relational resource model. In some examples, operation 906 can be implemented in a similar manner as operation 608 of FIG. 6.

In some examples, the policy comprises an attribute based access control policy.

After operation 906, process flow 900 moves to operation 908.

Operation 908 depicts associating a tag of the respective tags with the representation of the computing resource in the relational resource model, based on the tag template, to produce an updated relational resource model. In some examples, operation 908 can be implemented in a similar manner as operations 610-612 of FIG. 6.

In some examples, the tag comprises a key-value pair.

In some examples, the associating of the tag with the representation of the computing resource in the relational resource model facilitates identifying the computing resource, organizing the computing resource, searching for the computing resource, or filtering on the computing resource.

After operation 908, process flow 900 moves to 910, where process flow 900 ends.

FIG. 10 illustrates an example process flow 1000 that can facilitate policy-based tagging governance for cloud resource lifecycle management, in accordance with an embodiment of this disclosure. In some examples, one or more embodiments of process flow 1000 can be implemented by policy-based tagging governance for cloud resource lifecycle management component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, and/or process flow 1100 of FIG. 11.

In some examples where process flow 1000 is implemented in conjunction with process flow 900, the request is a first request, the computing resource is a first computing resource, a group of tag templates comprises the tag template, the policy is a first policy, the resource type is a first resource type, and the representation is a first representation.

Process flow 1000 begins with 1002, and moves to operation 1004.

Operation 1004 depicts receiving a second request to create a second computing resource.

After operation 1004, process flow 1000 moves to operation 1006.

Operation 1006 depicts determining that the second computing resource is not associated with any of the group of tag templates.

After operation 1006, process flow 1000 moves to operation 1008.

Operation 1008 depicts creating a second representation of the second computing resource in the relational resource model independently of determining that the second computing resource satisfies a second policy of the respective policies that corresponds to a second resource type of the second computing resource. In some examples, operations 1004-908 can be implemented based on following the NO branch of operation 506 of FIG. 5.

After operation 1008, process flow 1000 moves to 1010, where process flow 1000 ends.

FIG. 11 illustrates an example process flow 1100 that can facilitate policy-based tagging governance for cloud resource lifecycle management, in accordance with an embodiment of this disclosure. In some examples, one or more embodiments of process flow 1100 can be implemented by policy-based tagging governance for cloud resource lifecycle management component 108 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 1100 begins with 1102, and moves to operation 1104.

Operation 1104 depicts, based on receiving a request to create a computer resource, identifying a tag template of a relational resource model that models respective tags, respective policies, and respective computer resources as respective resources, and wherein the tag template corresponds to a resource type of the computer resource. In some examples, operation 1104 can be implemented in a similar manner as operations 604-606 of FIG. 6.

In some examples, the tag template comprises at least one condition to satisfy, and a naming convention for the tag. This can be similar to the following as described with respect to a tag template:
“conditions”: “Match_Organization && Match_Subscription”,
“convention”: “tag_name_convention””

In some examples, the representation is a first representation, and a second representation of the policy in the relational resource model comprises an identifier that comprises a primary key, a resource identifier that identifies one of the respective computer resources and comprises a foreign key, a rule, and at least one attribute. This can be similar to access control policy 226 of FIG. 2.

In some examples, the representation is a first representation, and a second representation of the tag in the relational resource model comprises an identifier that comprises a primary key, a name, a value, and tag template identifier that identifies the tag template and comprises a foreign key. This can be similar to tag 216 of FIG. 2.

In some examples the representation of the computer resource in the relational resource model comprises an identifier that comprises a primary key, a name, and an attribute. This can be similar to resource 202 of FIG. 2.

After operation 1104, process flow 1100 moves to operation 1106.

Operation 1106 depicts, based on determining that the computer resource satisfies a policy of the respective policies, creating the computer resource, and creating a representation of the computer resource in the relational resource model. In some examples, operation 1106 can be implemented in a similar manner as operation 608 of FIG. 6.

After operation 1106, process flow 1100 moves to operation 1108.

Operation 1108 depicts associating a tag of the respective tags with the representation of the computer resource in the relational resource model, based on the tag template. In some examples, operation 1108 can be implemented in a similar manner as operations 610-612 of FIG. 6.

After operation 1108, process flow 1100 moves to 1110, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of computer system 102.

In some examples, computing environment 1200 can implement one or more embodiments of the process flows of FIGS. 5-11 to facilitate policy-based tagging governance for cloud resource lifecycle management.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system comprising:
at least one processor; and
at least one memory that stores executable instructions that, when executed by the at least one processor, facilitate performance of operations, comprising:
maintaining a relational resource model, wherein respective tags are modeled in the relational resource model as respective first resources, respective policies are modeled in the relational resource model as respective second resources, and respective computing resources are modeled in the relational resource model as respective third resources;
based on receiving a request to create a new computing resource, identifying a tag template, wherein the tag template corresponds to a resource type of the new computing resource;
based on determining that the new computing resource satisfies a policy of the respective policies that corresponds to the resource type,
creating the new computing resource, and
creating a representation of the new computing resource in the relational resource model;
associating a tag of the respective tags with the representation of the new computing resource in the relational resource model, based on the tag template, to produce an updated relational resource model; and
storing the updated relational resource model in a computing memory.

2. The system of claim 1, wherein determining that the new computing resource satisfies the policy of the respective policies that corresponds to the resource type comprises:
evaluating a tagging policy condition function of the tag template based on a context associated with creating the new computing resource and resource type attributes of the new computing resource.

3. The system of claim 2, wherein the context associated with creating the new computing resource comprises resource parameters.

4. The system of claim 1, wherein the new computing resource is a first computing resource, wherein the policy is a first policy, wherein the resource type is a first resource type, and wherein the operations further comprise:
determining to refrain from updating the relational resource model for a second new computing resource based on determining that the second new computing resource fails to satisfy a second policy of the respective policies that corresponds to a second resource type of the second new computing resource.

5. The system of claim 1, wherein the operations further comprise:
executing a tag template convention function to create the tag based on a request context, a resource type context, and a tag template context.

6. The system of claim 5, wherein the executing of the tag template convention function is performed based on determining that the new computing resource satisfies the policy.

7. The system of claim 1, wherein creating the new computing resource is performed based on a use request context and a resource type context.

8. The system of claim 1, wherein the associating of the tag of the respective tags with the representation of the new computing resource in the relational resource model comprises:
binding the tag with the representation of the new computing resource as an attribute of the representation of the new computing resource.

9. A method, comprising:
based on receiving a request to create a computing resource, identifying, by a system comprising at least one processor, a tag template of a relational resource model wherein respective tags are modeled as respective first resources, respective policies are modeled as respective second resources, respective computing resources are modeled as respective third resources, and wherein the tag template corresponds to a resource type of the computing resource;
based on determining that the computing resource satisfies a policy of the respective policies that corresponds to the resource type,
creating, by the system, the computing resource, and
creating, by the system, a representation of the computing resource in the relational resource model; and
associating, by the system, a tag of the respective tags with the representation of the computing resource in the relational resource model, based on the tag template, to produce an updated relational resource model.

10. The method of claim 9, wherein the request is a first request, wherein the computing resource is a first computing resource, wherein a group of tag templates comprises the tag template, wherein the policy is a first policy, wherein the resource type is a first resource type, wherein the representation is a first representation, and further comprising:
based on receiving a second request to create a second computing resource, and based on determining that the second computing resource is not associated with any of the group of tag templates,
creating, by the system, a second representation of the second computing resource in the relational resource model independently of determining that the second computing resource satisfies a second policy of the respective policies that corresponds to a second resource type of the second computing resource.

11. The method of claim 9, wherein the policy comprises an attribute based access control policy.

12. The method of claim 9, wherein the tag comprises a key-value pair.

13. The method of claim 9, wherein the associating of the tag with the representation of the computing resource in the relational resource model facilitates identifying the computing resource, organizing the computing resource, searching for the computing resource, or filtering on the computing resource.

14. The method of claim 9, wherein the respective computing resources are respectively associated with no policies or with one policy.

15. The method of claim 9, wherein the respective tags are respectively associated with no policies or with one policy.

16. A non-transitory computer-readable medium comprising instructions that, in response to execution, cause a system comprising at least one processor to perform operations, comprising:
based on receiving a request to create a computer resource, identifying a tag template of a relational resource model that models respective tags, respective policies, and respective computer resources as respective resources, and wherein the tag template corresponds to a resource type of the computer resource;
based on determining that the computer resource satisfies a policy of the respective policies,
creating the computer resource, and
creating a representation of the computer resource in the relational resource model; and
associating a tag of the respective tags with the representation of the computer resource in the relational resource model, based on the tag template.

17. The non-transitory computer-readable medium of claim 16, wherein the tag template comprises:
at least one condition to satisfy, and a naming convention for the tag.

18. The non-transitory computer-readable medium of claim 16, wherein the representation is a first representation, and wherein a second representation of the policy in the relational resource model comprises:
an identifier that comprises a primary key, a resource identifier that identifies one of the respective computer resources and comprises a foreign key, a rule, and at least one attribute.

19. The non-transitory computer-readable medium of claim 16, wherein the representation is a first representation, and wherein a second representation of the tag in the relational resource model comprises:
an identifier that comprises a primary key, a name, a value, and tag template identifier that identifies the tag template and comprises a foreign key.

20. The non-transitory computer-readable medium of claim 16, wherein the representation of the computer resource in the relational resource model comprises:
an identifier that comprises a primary key, a name, and an attribute.
